(19) United States
(12) Patent Application Publication
(10) Pub. No.: US 2004/0179094 A1
(43) Pub. Date: Sep. 16, 2004

(54) Simplified 3D Viewer

(76) Inventor: Anthony Lo, Hong Kong (HK)

Correspondence Address: Anthony Lo, Rm. 7, 7/fl., New City Centr, 2, Lei Yue Mun Road, Kwun Tong, Kowloon, Hong Kong

(21) Appl. No.: 10/708,414

(22) Filed: Mar. 2, 2004

(30) Foreign Application Priority Data
Mar. 1, 2003 (GB) 0304728.9

(51) Int. Cl. H04N 13/00; H04N 15/00

(52) U.S. Cl. 348/42

(57) ABSTRACT

A foldable viewer having a collapsed state and an erected state. The viewer includes a collapsible and erectable viewing chamber, a viewing panel having a pair of lenses, an aperture panel having a pair of apertures, and a septum set into the aperture panel. The viewing chamber comprises front, rear, top and bottom planar walls which are contiguously joined, left and right walls joined to the front and rear walls but not joined to the top and bottom walls, and toggle tabs joined to the left and right edges of the top and bottom panels.

### CROSS REFERENCE TO RELATED APPLICATIONS

This application claims priority rights under 35 U.S.C. .sctn. 119(e)(1) based on provisional U.K. Patent Application GB 0304728.9 filed on 1st Mar. 2003.

### BACKGROUND OF INVENTION

The present invention relates to a stereographic viewer for viewing stereo photographs, also known as reflection prints.

The popularity of three-dimensional, or stereo, photographs is increasing along with technology advances in the field. Stereo photographs are created by projecting dual images of the same subject adjacent to each other on the same exposure of film. The dual images are known as a left and right stereo pair. This stereo pair can be viewed with three-dimensional, or stereo, effect, through an appropriate stereographic viewer.

The typical stereographic viewer achieves its purpose by directing light rays from the left hand image to the left eye and light rays from the right hand image to the right eye to create the effect of a single, merged stereo image. Ideally, the left eye should not receive light rays from the right hand image and the right eye should not receive light rays from the left hand image.

The Holmes style stereographic viewer comprises a pair of magnifying lenses mounted on a lens panel. A hood is provided around the lens panel to exclude stray light, which may strike the magnifying lenses and reflect back into the observers eyes. A septum is set between the 3D print and the lens panel to prevent the left eye from seeing part of the right image and the right eye from seeing part of the left image. To complete the masking of the images, the two side-by-side images are set in a pair of frames. Diopter adjustment is provided by sliding the print mount back and forth along the guide rail until a comfortable focus is achieved. This Holmes style stereographic viewer benefits from a hood because the lens panel is flat and the lens surfaces facing the eyes are flat so stray light will reflect back into the eyes.

The Holmes style stereographic viewer is renowned for comfortable, easy viewing of twin image 3D cards. However, it is heavy, rigid, complicated to fabricate and inconvenient to store and transport. It is not easily collapsible.

Another type of stereographic viewer for viewing twin image stereographs exists in the art. This is the box style stereographic viewer. This type of viewer is generally constructed from a cardboard blank having flaps or tabs, which must be folded and attached to various panels on the assembled box. Prior art box style stereographic viewers have been used for viewing stereographic transparencies. The pair of transparencies is placed on an image plane. The image plane forms the front wall of the box structure. The lens panel is set into the rear wall of the box. To view such stereo transparencies the viewer is held up to the light. Light shining through the transparencies set in the front wall is directed through the lenses to reach the left and right eyes, so creating a stereographic effect.

The prior art box style stereographic viewer for transparencies has the disadvantage that changing stereographic transparencies for viewing is inconvenient.

A prior art box style stereographic viewer has been used for viewing stereographic reflection prints placed within the box. A stereo reflection print pair is fixed on a panel, which is set into the front wall of the box. The lens panel is set into the rear wall of the box. The panels on either side are left open to allow light to enter the box. This is necessary because reflection prints require reflected light in order to deliver an image to the lens panel.

The prior art box style stereographic viewer for transparencies has the disadvantage that preparing and changing stereographic reflection prints for viewing is inconvenient. Also, there is no control over stray light entering the box through the open left and right panels.

The box style stereographic viewer for transparencies involves the use of an enclosed viewing chamber to block out stray light to enhance the clarity and perception of the viewed image pair. In practice it is very difficult to construct such a viewing chamber, make it both collapsible and erectable, and block out the stray light entering the viewing chamber. The prior art box style stereographic viewers have a collapsible and erectable viewing chamber, but they do not have a mechanism to conveniently secure the chamber in its erected position, which at the same time can be easily disengaged when the viewing chamber needs to be collapsed. Instead they rely on human fingers exerting pressure on the top and bottom walls of the box to keep the chamber in its erected position.

In light of the foregoing there is a need for a stereographic viewer that has a simple design and is capable of performing the functions of a Holmes style stereo viewer while having improved masking of stray light and being erectable for comfortable viewing of images and collapsible for convenient storage and transportation.

### SUMMARY OF INVENTION

Accordingly, the present invention is directed to a stereographic viewer that substantially obviates one or more of the limitations and disadvantages of prior art stereographic viewers. The advantages and purposes of the invention will be set forth in part in the description which follows, and in part will be obvious from the description, or may be learned by practice of the invention. The advantages and purposes of the invention will be realized and attained by the elements and combinations particularly pointed out in the appended claims.

To attain the advantages and in accordance with the purposes of the invention, as embodied and broadly described herein, the present invention is directed to a stereographic viewer that includes a collapsible and erectable viewing chamber, a viewing panel having a pair of lenses, an aperture panel having a pair of apertures, and a septum set into the aperture panel.

When this stereographic viewer is held with its aperture panel at an appropriate distance from a reflection print, light rays from the left hand image are directed through the let hand lens to the left eye and light rays from the right hand image are directed through the right hand lens to the right eye. This creates the effect of a single, merged stereo image.

The viewing chamber assembly allows light rays to enter through an aperture panel set into its front planar wall and exit through a lens panel set into its rear planar wall.

The configuration of the six walls allows the viewer to be erected when used and folded flat for convenient storage and transportation.

The toggle tabs joined to the left and right edges of the top and bottom panels serve form a seal that prevents stray light from entering the viewing chamber.

The toggle tabs can also be fully flattened when the viewer is in its collapsed state, but the arc of the fold acts as a buckled panel which has the natural tendency of holding the tabs in their folded position when the viewer is in its erected state.

It is to be understood that both the foregoing general description and the following detailed description are exemplary and explanatory only and are not restrictive of the invention, as claimed.

### BRIEF DESCRIPTION OF DRAWINGS

FIG. 1 is an isometric view of a Holmes style stereographic viewer, showing the relative positions of the lens panel, hood, septum assembly and the stereographic reflection prints to be viewed.

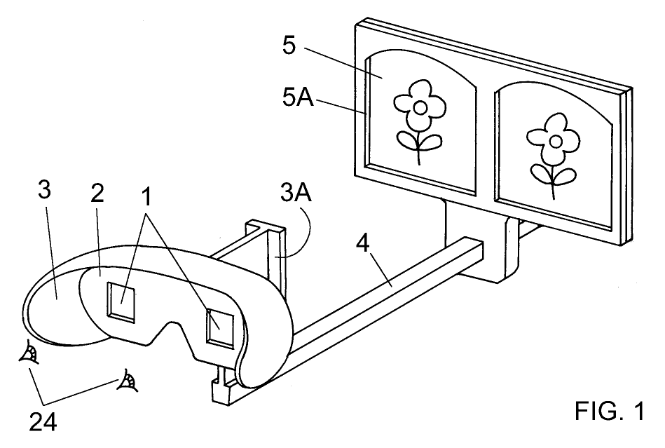

FIG. 2 is a top sectional view of a Holmes style stereographic viewer, showing the relative positions of the lens panel, hood, septum assembly and the stereographic reflection prints to be viewed.

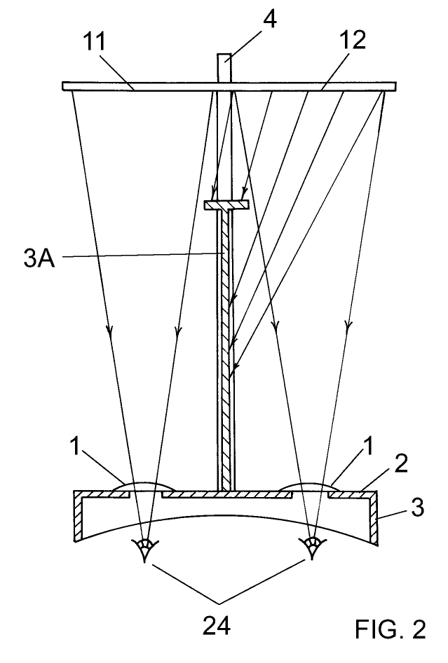

FIG. 3 is a simplified top sectional view of a Holmes style stereographic viewer showing how the lens surfaces can reflect external light towards the eyes of the observer, causing glare and degrading the stereographic view.

FIG. 4 is a top sectional view of a Holmes style stereographic viewer showing how a curved lens panel would help to reflect external light away from the eyes.

FIG. 5 is a top sectional view of the proposed improved Holmes stereographic viewer showing how the septum effectively blocks off all the unwanted right image from the left eye. The left image is also blocked off from the right eye (not shown in the figure).

FIG. 6 is an isometric view of the proposed improved Holmes style stereographic viewer, together with the stereo image pair placed outside the boundaries of the viewing chamber.

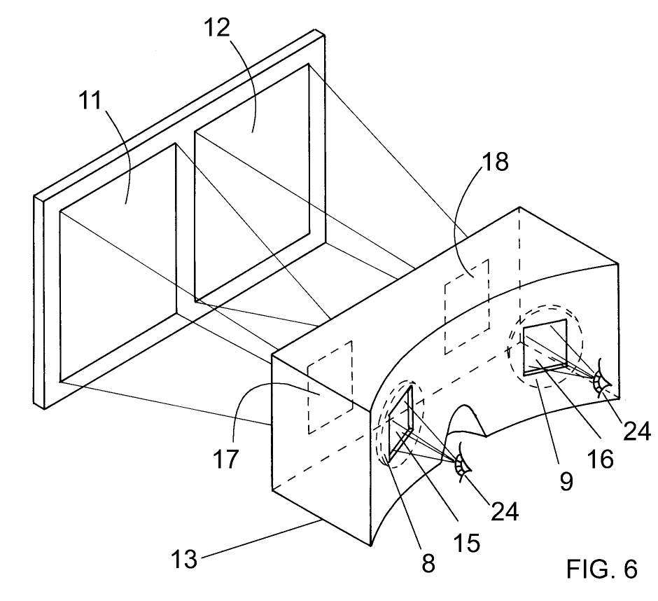

FIG. 7 is an isometric view of the proposed improved Holmes style stereographic viewer in its natural partially erected state.

FIG. 8 is an isometric view of the proposed improved Holmes style stereographic viewer in its fully erected but unlocked position.

FIG. 9 is an isometric view of the proposed improved Holmes style stereographic viewer in its erected state with the four toggle tabs engaged.

FIG. 10 is a sectional view of the toggle tabs showing the forces acting on the curved edges of the viewing chamber and the toggle tabs.

FIG. 11 is a flat, pattern diagram of the proposed improved Holmes style stereographic viewer, showing how a single piece of paper can be cut, folded and assembled into an erectable, collapsible stereographic viewer.

### DETAILED DESCRIPTION

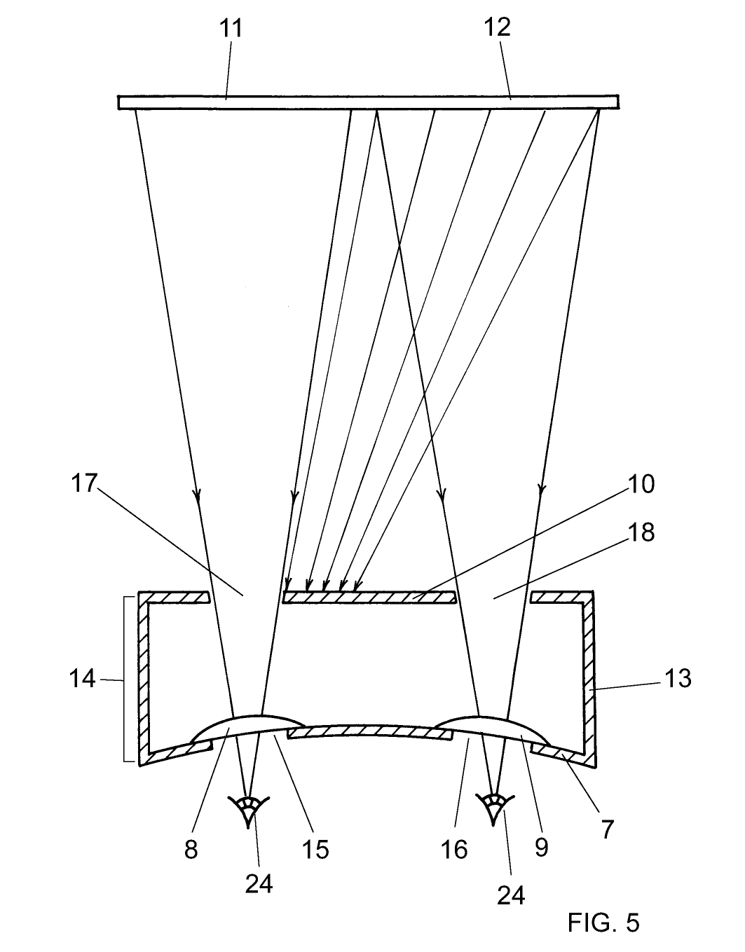

This invention offers an alternative, simplified design of the Holmes viewer. It retains the essential features of the Holmes viewer, addresses some of the shortcomings, and has other advantages related to modern trends and technology. FIG. 5 shows this viewer in its most basic form.

A pair of magnifying lenses is mounted on a concave panel 7 . Depending on the pitch of the images, prisms can be used.

Lenses 8 & 9 mounted on a concave panel 7 reflect stray light away from the eyes. By eliminating the hood 3, which must be big enough to accommodate eyeglasses, the design is simplified, and the viewer is far less bulky. It offers the additional advantage that the viewer no longer needs to touch the observer's face, which could be embarrassing for people wearing heavy make-up.

This invention has merged the septum and the aperture panel into a common piece (FIG. 5. item 10). By introducing a mask at a suitable distance from the eye piece (on the print side of the lenses), the area between the two frames is sufficient to prevent the left eye from seeing part of the right image and the right eye from seeing part of the left image. See FIG. 5, where the right image 12 is blocked by item 10 from reaching the left eye. Item 10 also blocks the left image 11 from reaching the right eye. For the sake of simplicity this is not shown in the diagram.

Besides providing a suitably sized, albeit slightly blurred, frame (stereo window) for the pair of 3D images, this frame is joined onto the lens panel with an opaque sleeve (FIG. 5 item 13). When viewing images through this viewer, the user gets the impression of being in a darkened room, watching a movie screen with no distracting stray light or images. This is an improvement on the performance of the Holmes viewer.

By disconnecting the viewer lens assembly from the print, but guided by left aperture 17 and right aperture 18, the observer is free to find the best viewing distance and position to suit his eyes 24.

Description of the Invention by an Example:

The invention is described by an example made of paper.

In practice, other foldable, ductile materials can be used.

Several refinements are described afterwards.

FIG. 5 shows the invention together with a pair of mounted 3D images and the user's eyes 24 in top sectional view. A pair of suitably mounted 3D images comprising the left hand image 11 and the right hand image 12 is held at a distance from the pair of objective lenses 8 & 9 so that the left eye is presented with a virtual image of the left image 11 focused at the about 2 meters in front of the left objective lens and the right eye is presented with a virtual image of the right image 12 also focused at about 2 meters in front of the right object lens.

An opaque box 14 with two pairs of openings on opposite panels is introduced in such a manner so that the pair of objective lenses 8 and 9 can be mounted over the pair of holes 15 and 16 so that the pitch between the centers of the holes 15 and 16 is approximately 65 mm, thus corresponding to the pitch of a typical pair of human eyes.

The pitch, size and shape of the apertures 17 and 18 are such that the left eye viewing through the left lens 8 can just see the whole of the left three dimensional image 11 framed within the aperture 17 and the right eye viewing through the right lens 9 can just see the whole of the right 3D image 2 framed within the aperture 18 . When the brain is presented with these two images, it will fuse them into a single image in 3D, framed as though one is looking through a window.

If the pair of 3D images 11 and 12 are already trimmed and suitably mounted to give an impression of seeing through a 3D window when viewed, then the two apertures 17 and 18 will act like a 3D window to the observer when this proposed viewer is used.

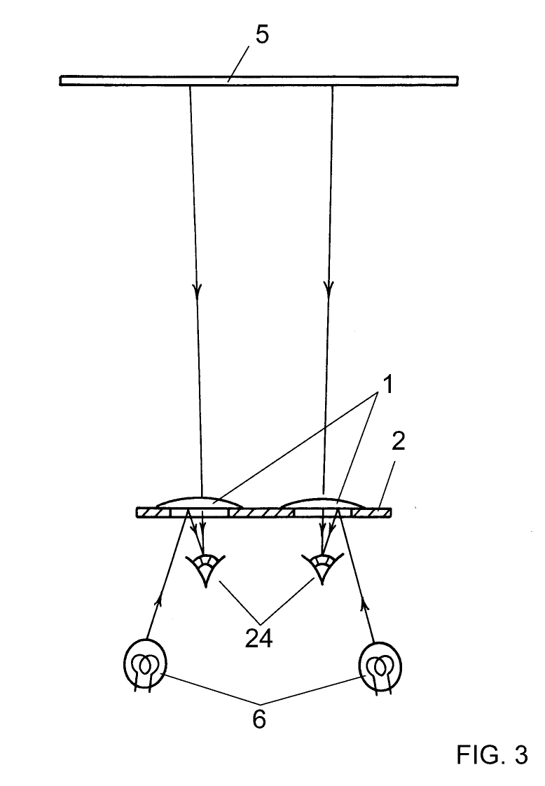

FIG. 3 shows how stray light 6 around the observer can sometimes be reflected by the polished surface of the lenses back toward the eyes 24.

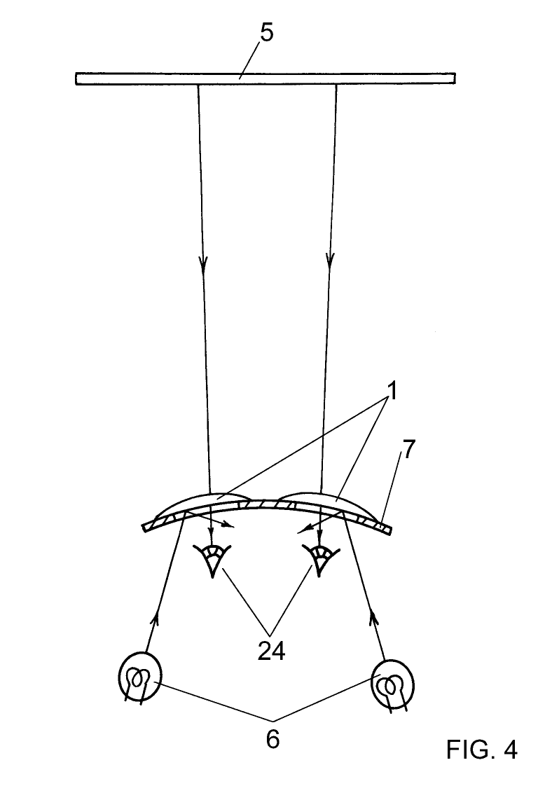

FIG. 4 shows another feature where the lens mounting panel is concave facing the observer. The lenses and polished surfaces are now at an angle to the stray light 6 and the glare is no longer reflected towards the observer's eyes 24.

Refinements to the invention:

The invention has the following refinements:

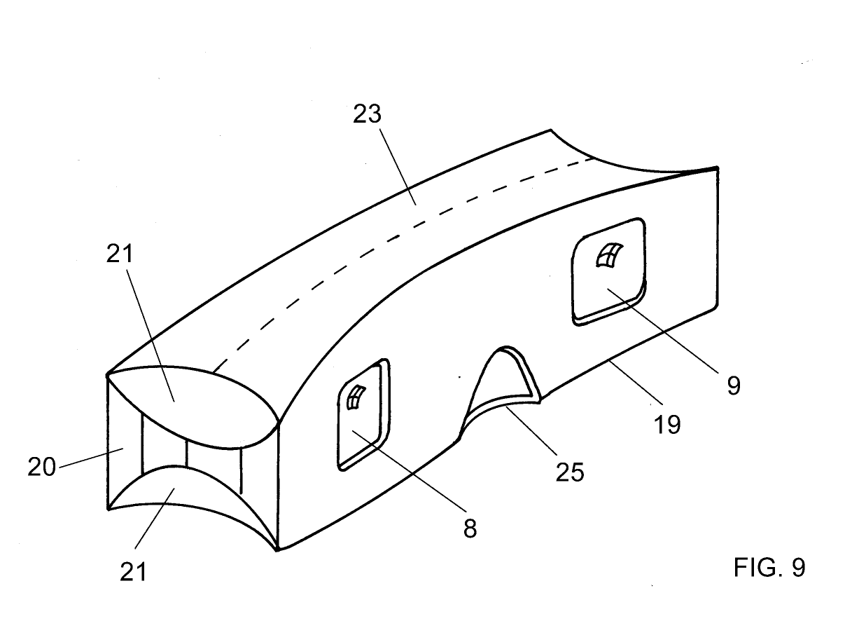

1. An erectable, collapsible, stereographic viewer, which can be made from a single piece of stiff paper or plastic card. FIG. 9 shows an erected viewer.

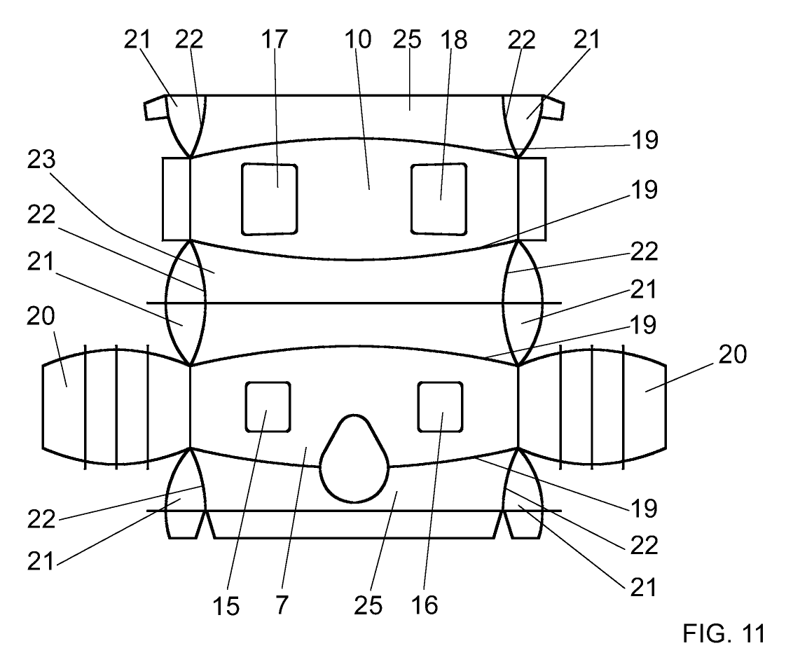

2. Curved crease lines (FIG. 11 item 19), which form a concave viewing plane when the viewer is erected.

3. Structural concertinas (FIG. 11 item 20) on each side allow the viewer to be compact and collapsible, and protect the lenses while collapsed.

4. When the viewer is opened for use it is kept erect by toggle locks on each side. The toggle locks consist of flaps of paper folding along a curved crease line (FIG. 11 item 22) acting as a hinge. These locks are strengthened by the top and bottom of each concertina forming a stiff ridge.

5. The opaque walls, concertinas and locking flaps on the side combine to provide a light-sealed viewing chamber. This viewing chamber gives the user the effect of viewing a projected image in a darkened theatre.

The first refinement addresses the issue of cost and ease of storage and transportation of the invention.

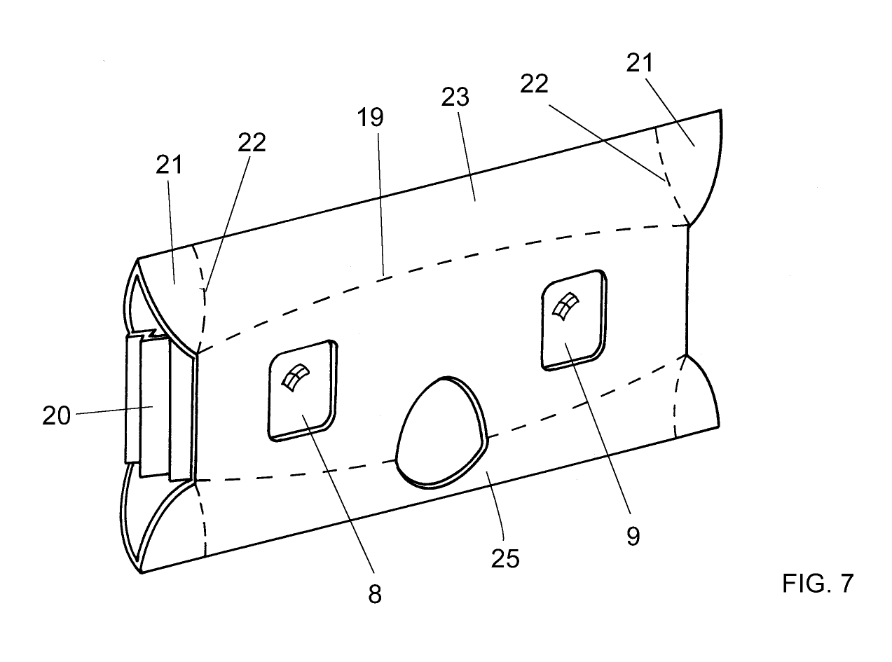

FIG. 7-FIG. 11 show the invention incorporating all the refinements described above. The design is also lightweight and collapsible. When collapsed it is thin and compact.

FIG. 7 shows the viewer partially collapsed. When fully folded, the structural concertinas 20 act as cushions to absorb load acting on the lens panel. When erected these concertinas act like ribs to provide vertical support for the top and bottom panels, giving the user's fingers a firm grip.

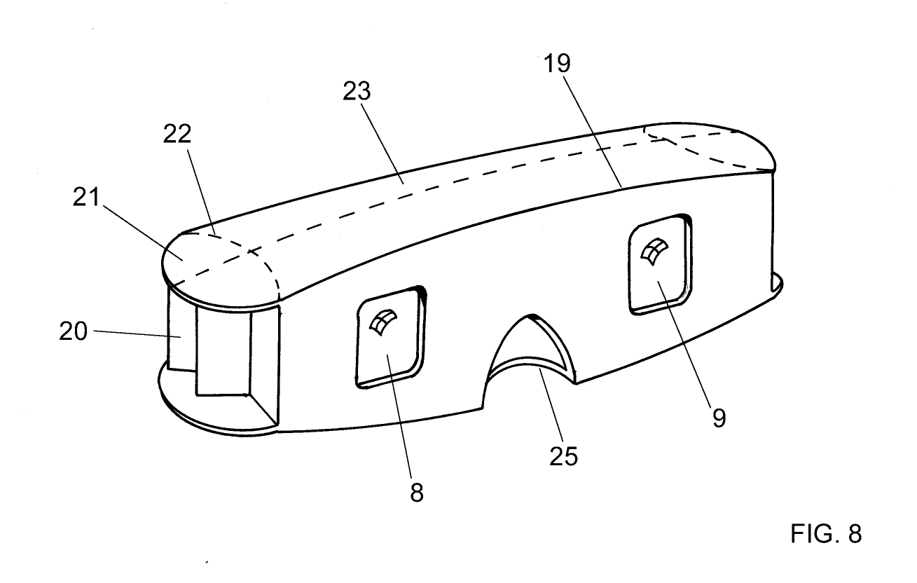

FIG. 8 shows the viewer fully erected but not locked, with the structural concertina 20 providing stiffness to support finger pressure.

FIG. 9 shows the four end pieces 21 folded over to lock the viewer in the erected position by acting like buckled tabs to prevent the top 23 and the bottom 25 walls from reverting to the collapsed position. The fold lines of these tabs are curved and this makes the folding action into a toggle. In the locked, erected, position, the stiffness of the paper at the folds of the viewer will tend to spring back into the collapsed position, this produces forces acting against the ends of the tabs. Due to the curvature of the fold, the tabs will buckle further into the locked position (see FIG. 8), thus making it self-locking.

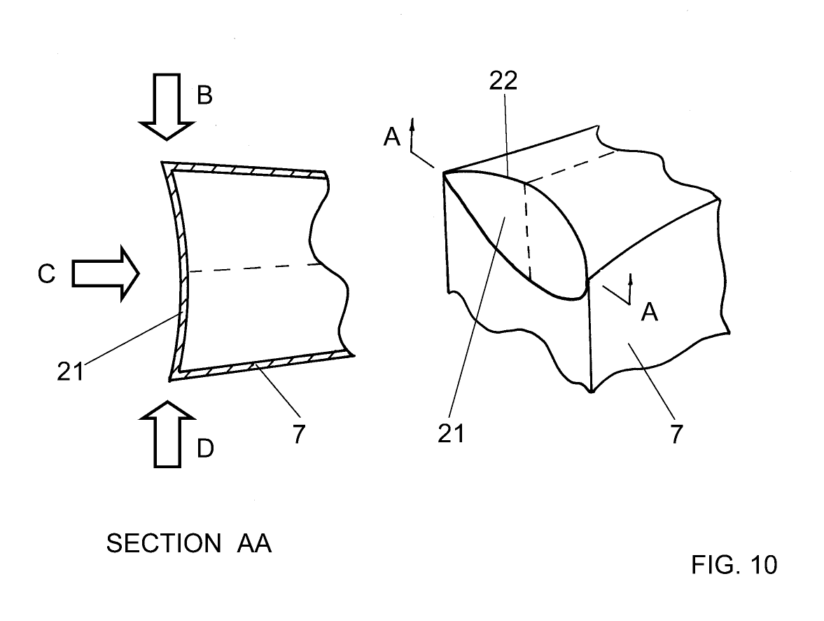

FIG. 10 shows a sectional view of the toggle tabs showing the forces acting on the curved edges of the viewing chamber and the toggle tabs. Natural forces in the folds around the edges of the viewing chamber trying to return the viewer to its collapsed or folded state can be resolved as impinging forces B and D, which are resisted by the buckled tab 21. this will generate a buckling force C tending to reinforce the locking action of the toggle tabs.

FIG. 11 is a flat, pattern diagram of the viewer, showing how a single piece of paper can be cut, folded and assembled into an erectable, collapsible viewer.

It will be apparent to those skilled in the art that various modifications and variations can be made in the construction of this stereographic viewer without departing from the scope or spirit of the invention. Other embodiments of the invention will be apparent to those skilled in the art from consideration of the specification and practice of the invention disclosed herein. It is intended that the specification and examples be considered as exemplary only.

1. A Stereographic (3D) Viewer for viewing stereo (three dimensional) images placed outside the boundaries of the viewer, comprising; a collapsible and erectable viewing chamber, a viewing panel having a pair of lenses, an aperture panel having a pair of apertures, and a septum set into the aperture panel; where light rays from the left hand image are directed to the left eye and light rays from the right hand image are directed to the right eye; to create the effect of a single, merged stereo image.

2. The septum of claim 1, wherein the separation of light rays from left and right hand images is achieved by a mask set into the aperture panel, filling the space between the two apertures.

3. The septum of claim 1 wherein the placement of the mask on the same surface as the picture frame allows the viewing chamber to be completely collapsed, with there being no additional pieces of masking material left between the front and rear panels.

4. A collapsible and erectable viewing chamber for a stereographic viewer comprising: front, rear, top and bottom planar walls which are contiguously joined; left and right walls joined to the front and rear walls but not joined to the top and bottom walls; toggle tabs joined to the left and right edges of the top and bottom panels.

5. The top and bottom planar walls in claim 4 wherein the edges of the front, rear, top and bottom planar walls are each folded on an arc to form a concave framing panel and lens panel when the viewing chamber is erected.

6. The top and bottom planar walls in claim 4 wherein the edges overhanging the left and right walls are folded on an arc and fitted with toggle tabs which act as locks to lock the viewing chamber in its erected position.

7. The toggle tabs of claim 4 wherein the tabs folded over the left and right side walls form a seal that prevents stray light from entering the viewing chamber.

8. The toggle tabs of claim 4 wherein the tabs can be fully flattened when the viewer is in its collapsed state, but wherein the arc of the fold acts as a buckled panel which has the natural tendency of holding the tabs in their folded position when the viewer is in its erected state.
